(19) United States
(12) Patent Application Publication
(10) Pub. No.: US 2008/0270179 A1
(43) Pub. Date: Oct. 30, 2008

(54) Scheduling module in clinical workflow tool for healthcare institutions

(75) Inventors: Marc Meiner, Ostheim/Rhon (DE); Stefan Scholl, Nuernberg (DE)

Correspondence Address: BRINKS HOFER GILSON & LIONE, P.O. BOX 10395, CHICAGO, IL, 60610, US

(73) Assignee: Siemens Aktiengesellschaft

(21) Appl. No.: 11/796,286

(22) Filed: Apr. 27, 2007

(51) Int. Cl. G06Q 50/00

(52) U.S. Cl. 705/2

(57) ABSTRACT

A scheduling module for use in method for simulation of a clinical workflow in a healthcare facility which models the processes and treatment of patients is described. The scheduling module accepts a requirement to perform a service on a target date and within a predetermined time window. Each service is characterized by required resources such as rooms, personnel, equipment, consumables, workplace and the presence of the patient. The scheduling module accesses the resource module to determine if the required resources are available during the predetermined time interval. When the resources are available, the resources are reserved and the scheduling module provides a unique identifier for the requested service to the workflow process.

The present application is related to U.S. application Ser. No. 11/363,919, filed on Feb. 28, 2006, and U.S. application Ser. No. ______, filed on Apr. 27, 2007, client matter number 2006P15973US (11371/140), by the same inventors.

### TECHNICAL FIELD

The present application relates to a scheduling module in a workflow simulation and in particular to a method for simulating workflow in a healthcare institution.

### BACKGROUND

The healthcare industry is under considerable pressure to improve performance and to reduce costs. The healthcare facilities must be always be mindful of costs, resource utilization, timeliness of care, and efficiency of processes. In order to address issues in this area, consultants are generally hired to work with a healthcare facility to improve specific situations at the facility. Based on individual and facility specific workflow analysis, proposals for improvement are presented to the facility as a typical result of the project. The consulting project requires highly skilled people with process and medical knowledge and specific tools in order to accomplish the desired goals. The impact of changes in the processes and in the workflow on the operational and financial state of the healthcare facility is often based on an estimation utilizing standard parameters such as reimbursements rates, human resource costs, equipment and material costs, maintenance costs and the like, which are not considered as a dynamic interaction between different processes and workflows.

A healthcare facility needs a method and tool to provide a measure of a proposed change in a clinical workflow process before investing in infrastructure and re-engineering of processes.

Scheduling of activities, equipment and personnel in a hospital is a challenge due to the complexity of the interaction between the different aspects of the utilization of resources. Scheduling tasks may include transportation of patients, resource utilization planning, maintenance, and the like. Presently, several methods and tools are used in the clinical environment for scheduling. The activity can be performed manually by a specific trained resource (e.g. a scheduling administrator) or using computerized tools. Advantages of a manual procedure are that it is highly flexible and individualized. Disadvantages of a manual procedure are that it is slow, it is not standardized, and it has a high rate of errors. A computerized system has advantages of being standardized, fast and has a lower error rate. However, corresponding disadvantages include lack of individuality and lower flexibility. A Clinical Workflow Simulation Tool and Method (CWST) has been described in U.S. application Ser. No. 11/363,919 filed on Feb. 28, 2006, by the present inventors, which is incorporated herein by reference. Different modules are needed to operate the CWST. At present there is not a scheduling tool available for use in a CWST.

### SUMMARY

A scheduling module for a workflow simulation tool for a healthcare facility is described, including software stored on a computer readable medium and operable on a computer to provide a user interface for entering data for requesting a service to be performed on a target date and within a predetermined time interval. The scheduling module accesses a resource module and determines if the resources required by the requested service are available within the predetermined time interval. When the resources are available, the scheduling module assigns a unique identifier to the service and provides the data to a workflow simulator.

A method for using a scheduling module in workflow simulation in a healthcare facility is described, including the steps of inputting data requesting a service to be performed on a target date and within a predetermined time interval. The scheduling module accesses a service module containing data characterizing the resources needed during the particular time period. After that, the scheduling module may access different resource modules to determine if the resources for the requested service are available. If all specified resources are available, the scheduling module assigns a unique identifier for the scheduling request, which indicates to the workflow simulator that a possible target date for performing the service was found within a given time interval. Additionally, each individual resource allocated to the identified service is marked for the target date to indicate that the resource is not available for other services during that period of time.

### BRIEF DESCRIPTION OF THE DRAWINGS

FIG. 1 (A, B) is a chart illustrating steps in workflow example for a patient with an acute myocardial infarction;

FIG. 2 (A, B) is a chart illustrating workflow modules assigned to the workflow steps;

FIG. 3 is an representation of a timeline of resources need to perform a service on a target date; and

FIG. 4 shows the relationship of the resource descriptors and service resource requirements to the scheduling module.

### DETAILED DESCRIPTION

Exemplary embodiments may be better understood with reference to the drawings. Like numbered elements in the same or different drawings perform equivalent functions.

A clinical workflow simulation tool (CWST) may be thought of as a component of an overall construct called a CPRM (Customer Process Reference Model), which is a means of modeling the medical process so as to structure medical processes. The CPRM may consist of at least four levels. Level 1 may be the overall business processes of the health care facility (e.g., patient process, supply chain process, and the like). Level 2 may be a medical functional categorization (e.g., Diagnosis, Treatment, Discharge, and the like). Level 3 may be medical paths (e.g., Lab tests, Non-Invasive Imaging, Invasive Procedures inside an operating theater, and the like). Level 4 may be the workflow level, which describes the steps needed to perform a Level 3 building block path (e.g. what may be done inside a specific path, such as a MR-Head-Diagnosis). Lower levels of the CPRM model may include the simulation activities needed to optimize performance and these may be addressed by a CWST.

A scheduling module for a method and tool for simulation of clinical workflow in a healthcare facility in order to quantify specific facility processes and workflows is described. Measures of operational and financial parameters are obtained and the operational and financial parameters are compared both before and after proposed changes in the processes and workflows. In order to input the data into the method and tool, the input information is obtained much the same way as with consulting projects for a healthcare facility. In particular, specific questions are raised such as, “what are the costs of clinical services such as operating rooms or stroke units”, “what are the benchmarks to compare these costs with,” “what are the actions and changes that should be implemented”, and “what are the consequences of these changes”. With these questions, parameters are defined such as costs per case, utilization rate for the operating theater, the number of nurses per case, the time for specific procedures, the patient transportation times, and the like. The data for the specific healthcare facility environment is measured. Examples of the measurements include that an analysis of the cost structure for the facility, a count of how many cases are handled in a specific area or during specific period of time, the number of nurses compared to the number of cases in specific time periods, how long a specific procedure runs in a specific time period, how long it takes for transportation of a patient from one point to another, etc.

The gathering of data is by answering the questions raised and defining and measuring the parameters which affect that question. Other data gathering is also possible. In order to implement the present method, specific data may be needed, such as measurements of the times needed for a nurse or a physician or technician to go to from one point to the next at the health care facility. The patient preparation time is determined, the day and night shift timed differences are determined, and the hospital layout is input. The data is gathered by conducting measurements in the healthcare facility environment during real world operations, for example, by either an outside consultant or by dedicated data gathering personnel. This type of data is not typically used in a consulting project but is utilized according to the present simulation tool.

The data input portion of the method may utilize a map to process the input into the system in order to map the client hospital or health care facility layout to the processes and assign resources to the process steps as well as to give time periods for the process steps, assign work places to the process steps, assign patients to the process steps, and define the interferences in the process.

In an example, the simulation tool is a software program or set of programs that is operable on a computer and is stored on computer readable media. The computer or computer system accepts inputs and performs the simulation and provides outputs by standard computer hardware, display devices, and software. The computer may be a stand-alone computer or may be connected to a network. More than one computer may be used, with different functions being performed by different computers.

In an another example, the clinical workflow simulation tool and method provides, for example, patient and client processes along with resource lists of human, technical and infrastructure resources, information on worker shifts, costs of defined resources, capacities for the resources, interferences between the processes, and resources at the specific healthcare facility user interface.

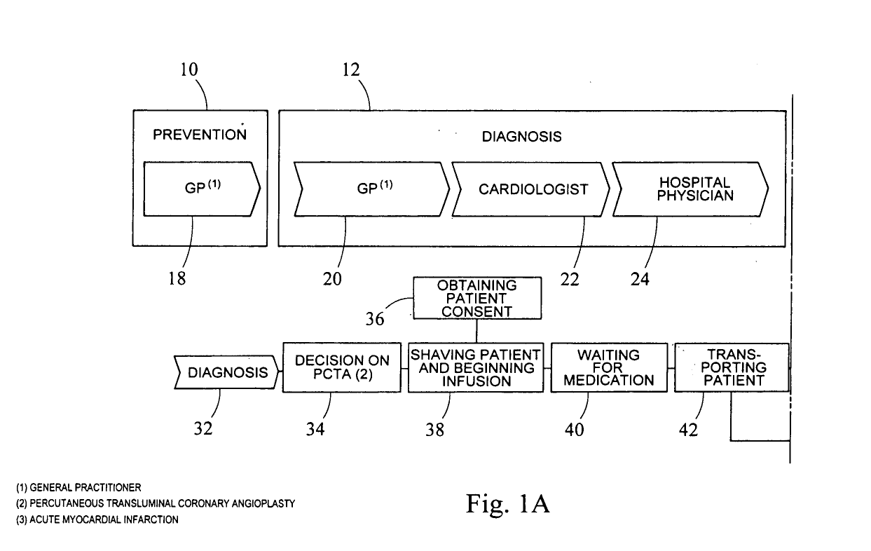

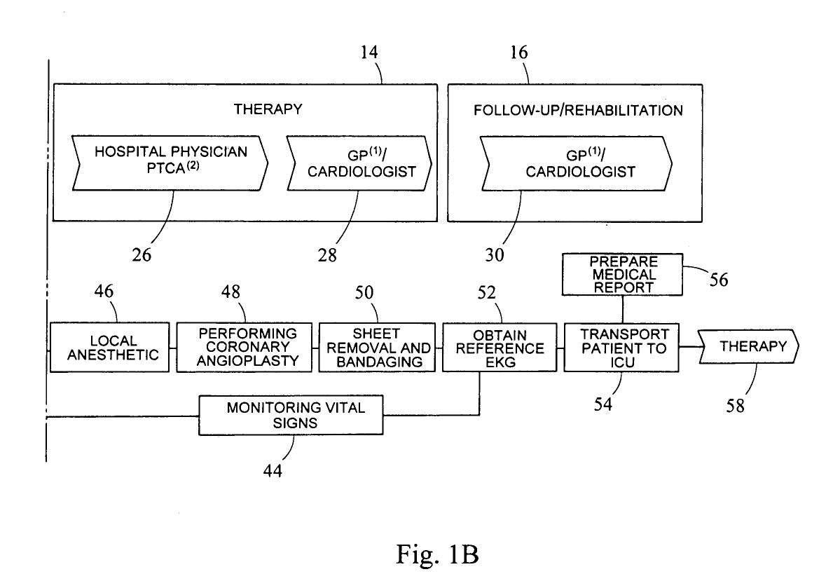

The collected data may be used to generate a clinical workflow as shown in FIG. 1. The clinical workflow illustrates the workflow processes for a healthcare facility for a patient with acute myocardial infarction (AMI) who is to be treated by percutaneous transluminal coronary angioplasty (PTCA). The upper portion of the illustration shows the major stages of the process including prevention 10, diagnosis 12, therapy 14, and follow-up and rehabilitation 16. The personnel who oversee processing in each major stage are indicated in each stage block. For instance, the prevention stage 10 is carried out under the authority of the general practitioner, indicated as GP in the drawing. The diagnosis stage 12 begins with the general practitioner at 20, consultation is carried out with a cardiologist at 22 and then the matter is referred to a hospital physician at 24. The therapy stage 14 is initiated by the hospital physician who carries out the PCTA and following the PCTA procedure the patient responsibility is transferred to the general practitioner or cardiologist or at least consultation is carried out with these doctors at 28. The follow-up and rehabilitation stage 16 is the responsibility of the general practitioner and cardiologist at 30.

The illustrated stages include process steps for each of the steps in the main process stages. For example, the therapy stage 14 by the hospital physician who performs the angioplasty includes the steps indicated in the lower portion of FIG. 1 wherein the therapy stage is begun with diagnosis 32, followed by a decision to perform the percutaneous transluminal coronary angioplasty (PCTA) at 34. This is followed by providing information to the patient and obtaining patient consent at 36 and installation of an intravenous line, shaving the patient and beginning infusion at 38. Thereafter, a step of waiting and pre-medication 40 is an element to be considered in the process. The patient is then transported to the cathlab (catheter laboratory) at 42. At this time, there may be continuous monitoring of vital signs as indicated at 44. Once in the cathlab, a local anesthesia is applied at 46, and the percutaneous transluminal coronary angioplasty is performed at 48. Following the angioplasty procedure, the operating sheets or drapes are removed and the patient is bandaged at 50. A reference EKG (electro-cardiogram) is then taken at 52. Following the EKG, the vital signs monitoring 44 is discontinued. The conclusion of this stage of the therapy includes the transportation of the patient to the intensive care unit (ICU) at 54 and preparation of a medical report at 56. The therapy then continues as indicated at 58.

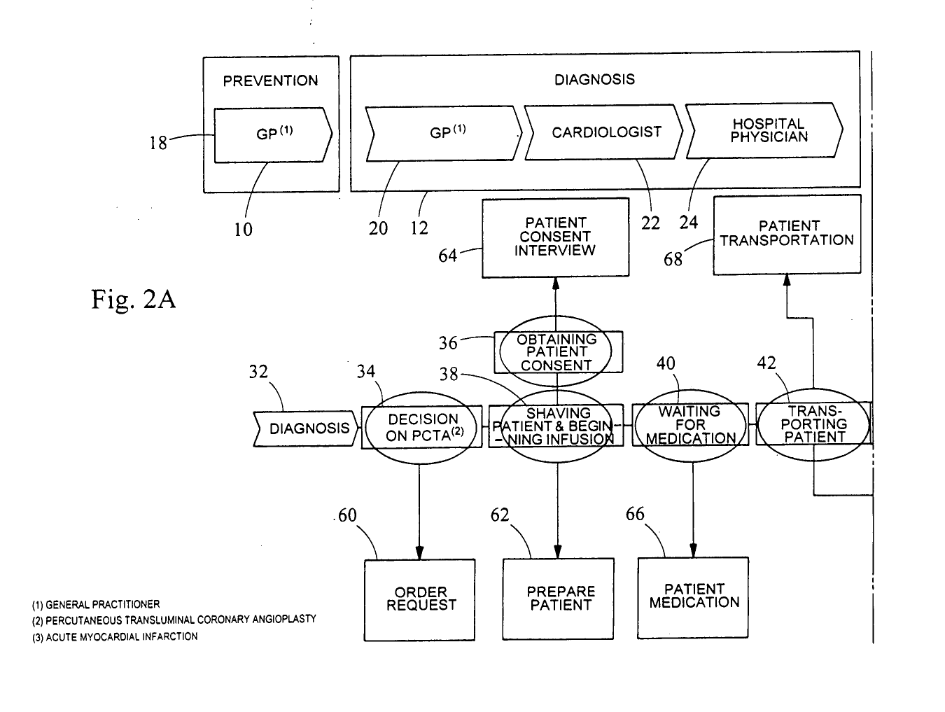

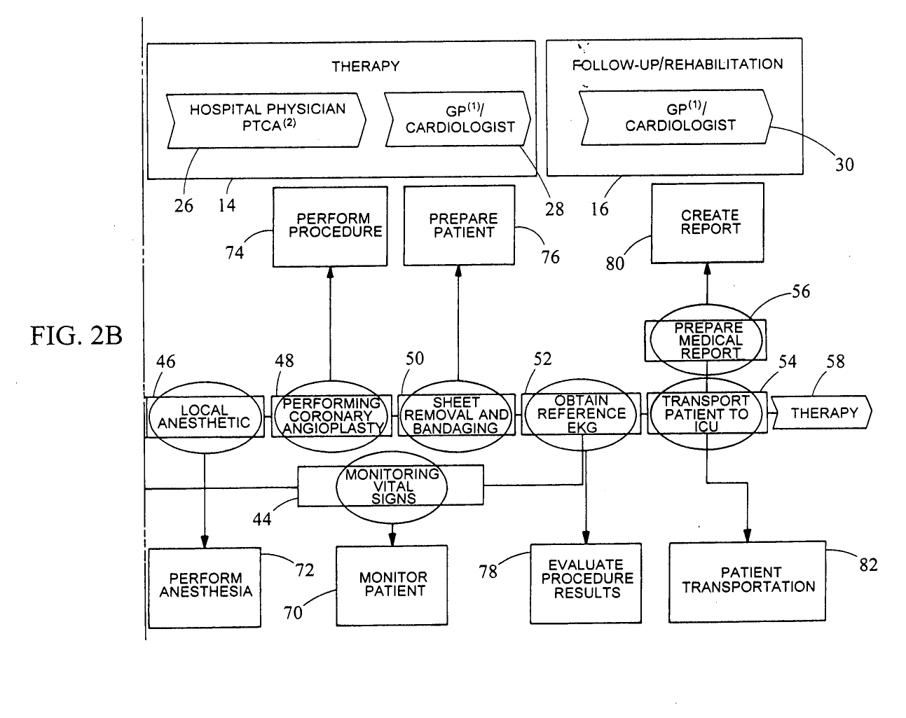

With reference to FIG. 2, the patient treatment steps may be clustered in modules. Each module is a step in the clinical patient workflow. In FIG. 2, the primary stages 10-16 are the same as those of FIG. 1. The steps of the PTCA performed under the authority of the hospital physician are indicated in the lower portion of FIG. 2. For example, the decision to perform the PTCA 34 has allocated to an order request module 60. The intravenous line insertion, shaving of the patient, and infusion of intravenous fluids at step 38 is allocated to prepare the patient module 62. Substantially simultaneously thereto, the inform the patient and patient consent step 36 has allocated to it a patient interview consent module 64. The waiting and pre-medication step 40 has a patient medication module 66 allocated to it. The transport to cathlab step 42 has allocated to it a patient transportation module 68. The vital signs monitoring steps 44 has a monitor the patient module 70 allocated to thereto. The local anesthesia step 46 includes a module to perform the anesthesia at 72. The PTCA step 48 includes performing the procedure module at 74. The sheet removal and bandaging step 50 includes the preparing the patient module 76. In the reference EKG step 52 an evaluate procedure results module 78 is provided. The medical report step 56 includes report creating module 80 while the transport to intensive care unit step 54 includes a patient transport module 82, which may be the same or a similar module as the patient transport module 68.

Modules of the clinical workflow may also interact with the resources available in the health care facilities. As such resources are finite and the demand for resources may conflict during a particular period of time, for workflows associated with the same or differing procedures, another module which may be used in the CWST is a “service module.” A service module represents a typical service or procedure relating to a patient, where the resources and materials are those nominally expected during the performance of the procedure or service. A service module may be parameterized to particularize the service or procedure to be performed. The resources scheduled to be used in performing the service or procedure are components of the service module parameters. Each resource may have specific attributes used in the service module parameterization.

The process of filling in the values for parameters of a resource is called instantiating the resource, and a resource which has all of its parameters filled in may be called a resource instance. The resource instance is the resource is described by the parameters allocated to the resource. By interacting with other modules which may create pools of specific types of resources, such as devices, personnel by skill, and the like, the finite nature of the resources may be introduced into the model and simulation.

In an aspect, a service may be defined by a set of parameters such as:

Name of the service;

Time period of the service;

Time interval before the start of the service where the patient is present;

Priority of the services; and

Resource required, including description of location, time of service and duration of service.

As an example, the resources may be associated as clusters exhibiting related attributes. In an aspect, such a clustering of attributes may lead to a definition of resources as:
Cluster 0: rooms;
Cluster 1: personnel;
Cluster 2: equipment;
Cluster 3: consumable supplies;
Cluster 4: patient;
Cluster 5: workplace (that is, the actual position of the personnel or mobile device, such as at a scanner console);
Cluster 6: carrier (such as a bed, wheelchair, or no carrier (patient on foot), and
Cluster 7: synchronizer (team-resources, e.g. OP-Team-1).
Cluster 8: information systems (e.g. HIS, RIS, MR-Host-Computer)

Scheduling is the function of synchronizing one or more resources coordinated by a target date. The goal of a scheduling module is to fulfill as specific requested service with the available resources. The scheduling module accesses other modules in the CWST to determine the availability of the resources needed for the service in a predefined time window. If all of the resources are available during the specific time window or windows specified, the planned service can be performed.

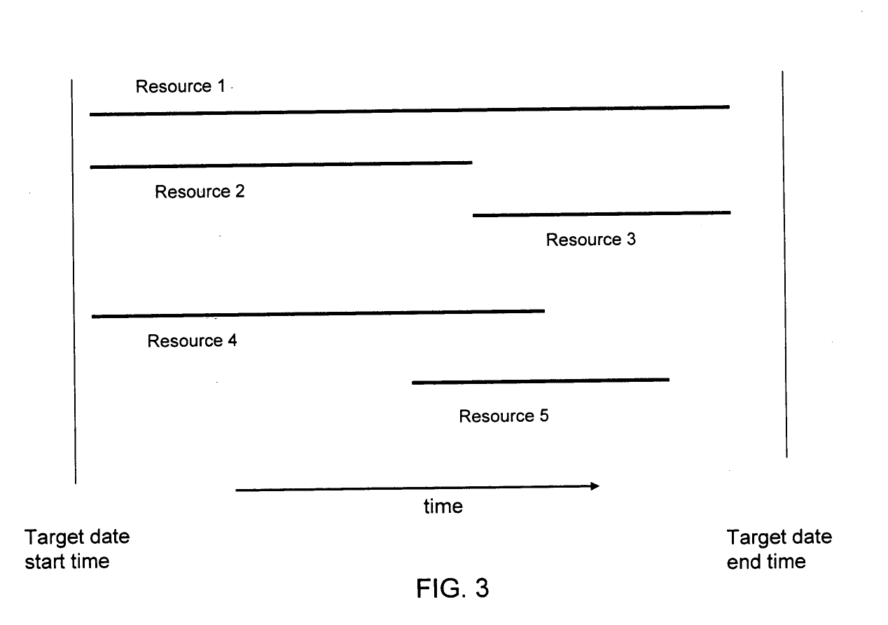

A target date defines the need for one or more resources. Depending on the service being modeled, the resources may need to be available in parallel, partially in parallel, or in a serial manner. Thus, the need for a resource is specified within a target date based on the time period of required availability, and the priority of the resource. An example of such a configuration of resources is shown in FIG. 3.

The resources are scheduled in the target date as a percentage of the total time period for performing the service, and located within the target date period based on the need for the particular resource. As such, the resource is allocated for the time period needed, and need not necessarily be reserved for the complete service period. Several resources can be planned on one calendar by a synchronizer module, so that the resources of a team (e.g. a surgical team for an operating theater) may be effectively planned.

Each scheduling request which identifies a possible target date will receive a unique identification number (ID) from the scheduler and the scheduler may use this ID for resource re-planning, such as rescheduling, declining, or canceling a service. Each resource may be described as having a start time, a time duration and, optionally, a location at which the resource is available. Each resource may be linked to a particular hospital department (e.g., radiology). As described above, resources may be classified as, for example, personnel (e.g. physician, nurse, technician, or the like), patient, equipment (fixed or mobile), and consumables. The latter is a quantity of material which needs to be available for a particular service, but the time of availability may not be specifically scheduled. The other resources have an associated calendar function so that the availability of a resource may be reserved for a particular calendar date and time. Each resource having a calendar may be scheduled, while resources without an associated calendar are available as needed.

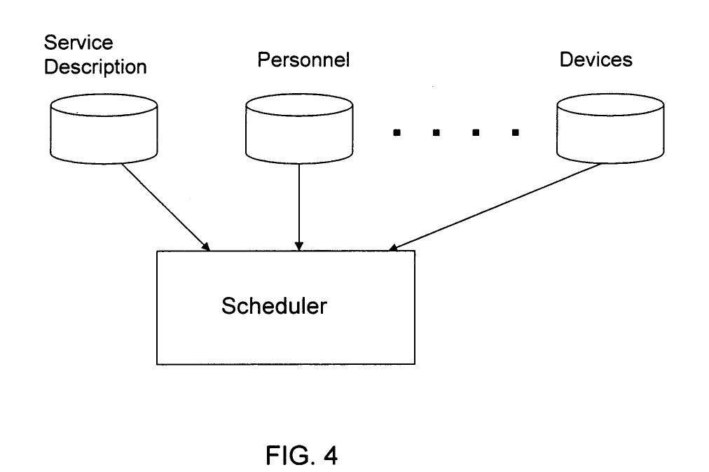

FIG. 4 shows the interaction between the resource descriptions and the scheduler module of the CWST.

The scheduler is provided with a service definition where the resource needed is identified with a target date, location and time duration. The scheduler accesses other modules of the CWST so as to obtain information needed to establish a target date service ID number. These may include, but are not limited to: the target date; patient identification (e.g., name), time window which the service may be initiated, and whether the case is an emergency or not. When the planning process successfully identifies the resources an ID number may be assigned; when the planning process is not successful, and ID number is not assigned.

The scheduling procedure may be repeated until a start time during the time window results in successful identification and allocation of resources, or the time window expires. That is, when assigning the ID number, the scheduler has identified the earliest time slot for which all of the required resources to provide the service can be identified and reserved. If the resources are not available for the earliest time slot, the scheduler tries again for the next time slot. The next time slot is later by a predefined time interval.

The determination of availability of a time slot may include, for example: determination of the locations where the necessary equipment and consumables are available; the availability of mobile equipment; availability of staff; and, availability of the patient. In an example, consider a patient needing an appointment for a service (e.g., MR head) at a particular time or time period. The appointment needs a physician associated with the radiology department, a nurse linked to the service and a room having a suitable magnetic resonance (MR) imaging device installed therein. At this time, a specific physician, nurse or room is not allocated; only resource reservations are made. The mobile resources (e.g., personnel, transport carrier, and the like) and the dedicated resources are allocated to the scheduled services, but specific individuals, equipment or rooms may not be identified until a short time prior to the scheduled time for the service. Another module allocates these resources from those previously reserved but, in the event that the resource is not available, the module attempts to find a replacement.

The scheduler obtains the description of the service to be provided from a service module and determines the availability of the resources from the resource modules. The scheduler may operate by obtaining the description of a room needed for a service, including the devices which are needed to perform the service, searching the inventory of rooms in the resource module to identify the rooms suitable for the service; determining the rooms from the inventory of rooms that are available for the time slot; and prioritizing the room based on the service to be provided.

There may be two different kinds of prioritization. Each room may have a priority to determine if a particular service is allowed to be planed for a room. For example, all needed devices and consumables are available with in a specific treatment room or inside an operation theater. If the priority of the service is higher or equal to the room priority, the service may plan to use the room (e.g., emergency cases are allowed to use any possible room). The second kind of prioritization is prioritization within possible resources. If more than one resource is available for a service, the prioritization may select the best example of the resource based on different strategies (e.g., not blocking other processes or services, closest resource to patient, cost, and the like.)

Mobile devices which may be needed to perform the service are selected based on the priority of the service. The availability of the staff needed, taking account of qualifications and professions are identified in the personnel resources manager and prioritized based on the service priority. The availability of the patient is also checked with respect to the time of performance of the service.

When each of the appropriate resources has been identified and reserved, the service may be considered to have been scheduled for the target date and time slot.

In running the simulation, the actors for each module, the location in the healthcare facility and other factors, many of which are specific to the healthcare facility, are taken into account. The simulation not only involves simulating a single workflow but also simulating workflows of other processes taking place at the healthcare facility so that interactions between workflows is simulated.

Once the clinical workflow is modeled in the system, it is now possible to measure parameters within the workflow. Relevant parameters based on clinical, operational or financial questions can be defined in the healthcare facility workflow. Various questions can be answered and variations in parameters are possible.

The instructions may be stored on a removable media device for reading by local or remote systems. In other embodiments, the instructions may be stored in a remote location for transfer through a computer network, a local or wide area network, by wireless techniques, or over telephone lines. In yet other embodiments, the instructions are stored within a given computer, system, or device.

Although only a few examples of this invention have been described in detail above, those skilled in the art will readily appreciate that many modifications are possible without materially departing from the novel teachings and advantages of the invention. Accordingly, all such modifications are intended to be included within the scope of this invention as defined in the following claims.

What is claimed is:

1. A scheduling module for a workflow simulation tool for a healthcare facility, comprising:
software stored on a computer readable medium and operable on a computer to perform the following steps:
accepting a request for a service to be performed on a target date and starting within a predetermined time window;
accessing a service module;
determining the availability of resources specified in the service module by accessing resource modules;
wherein the resource availability is determined for a start time and duration within the predetermined time window; and
assigning an identification to a request for service when the resources have been determined to be available.

2. The scheduling module of claim 1, wherein resources are the patient personnel, rooms, equipment, and consumables.

3. The scheduling module of claim 2 wherein the availability of resources is calendarized such that each target date has a separate resource availability.

4. The scheduling module of claim 2, wherein the resources are prioritized and the availability of resources is such that resources with a priority less than or equal to the priority of the service are selectable.

5. The scheduling module of claim 1, wherein the time window comprises multiple start times, separated by predetermined time intervals, and the determining of resource availability is performed for successive start times until either the resource availability has been determined, or the predetermined time window has been exhausted.

6. A method for using a scheduling module in workflow simulation in a healthcare facility, the method comprising:
inputting data requesting a service to be performed on a target date and within a predetermined time interval;
retrieving data characterizing resources required by the service by accessing a service module;
retrieving data characterizing resource availability by accessing a resource module;
determining if the resources required by the service are available during the target date and within the predetermined time interval; and
providing a service identifier to the workflow simulator when the required resources are determined to be available.

7. The method of claim 6, wherein the resources include at least personnel, rooms and equipment.

8. The method of claim 6, further comprising marking the individual resources identified as available as being reserved for the service having the service identifier for the target date and within the predetermined time interval of the service.
